(19) United States
(12) Patent Application Publication
(10) Pub. No.: US 2026/0024917 A1
(43) Pub. Date: Jan. 22, 2026

(54) DUAL BAND PATTERN RECONFIGURABLE MILLIMETER WAVE ANNTENNA FOR JOINT COMMUNICATION AND SENSING

(71) Applicant: Khalifa University of Science and Technology, Abu Dhabi (AE)

(72) Inventors: Sagiru Mukhtar Gaya, Abu Dhabi (AE); Mohamed A. Abou-Khousa, Abu Dhabi (AE); Mohamed Saeed AlShehhi, Abu Dhabi (AE); Khaled Al-Wahedi, Abu Dhabi (AE); Ademola A. Mustapha, Abu Dhabi (AE)

(21) Appl. No.: 19/273,552

(22) Filed: Jul. 18, 2025

Related U.S. Application Data
(60) Provisional application No. 63/673,552, filed on Jul. 19, 2024.

(51) Int. Cl. H01Q 9/04; H01Q 3/38; H01Q 25/00

(52) U.S. Cl. CPC H01Q 9/0407; H01Q 3/385; H01Q 25/001

(57) ABSTRACT

Dual resonance pattern reconfigurable antennas for sensing and communication are disclosed. A dual resonance pattern reconfigurable antenna includes a substrate, a patch antenna, a trace assembly that extends around a perimeter of the patch antenna, and a PIN diode. The trace assembly includes a first trace and a second trace. The first trace extends along a first trace length of the first side perimeter and is separated from the first side perimeter. The second trace includes a second trace top side segment that extends along the top side perimeter. A first gap separates the second trace from the first trace. The PIN diode is connected between the first trace and the second trace. The antenna is reconfigurable between a first biasing state and a second biasing state. The PIN diode is in an ON-state in the first biasing state. The PIN diode is an OFF-state in the second biasing state.

### CROSS-REFERENCE TO RELATED APPLICATIONS

This application claims the benefit of U.S. Provisional Patent Application No. 63/673,552, filed Jul. 19, 2024, the entire contents of which are hereby incorporated by reference for all purposes in its entirety.

### BACKGROUND

Joint Communication and Sensing (JCAS) has been identified as a novel feature of future 6G technology with many potentials and challenges. In the forefront of 6G technology and the Internet of Things (IoT), innovative millimeter wave (mm-wave) antennas play a crucial role. To address the challenges associated with JCAS, pattern reconfigurable antennas have emerged as a viable enabling solution, since they can offer different operational modes. Having more than one operational mode may enable the employment of the antenna for simultaneous sensing and communication.

Pattern reconfiguration has been accomplished through diverse techniques, including electrical switching, mechanical switching, and the use of meta-structures such as electromagnetic bandgap structures (EBG). Electronic pattern configuration techniques employ components such as PIN diodes, varactor diodes, radio frequency microelectromechanical systems (RF-MEMS), and radio frequency field-effect transistors (RF-FETs) to control the radiation pattern of the antenna. Among these, the application of PIN diodes is prevalent due to its advantages, such as cost-effectiveness and faster switching times. At lower frequencies (between 2 GHz to 10 GHz), numerous designs for pattern reconfiguration using PIN diode have been proposed. While existing approaches have demonstrated antenna radiation pattern reconfiguration at these lower frequencies, their reliance on active devices such as PIN diodes and reconfigurable power dividers poses challenges particularly in the context of mm-wave communication. A notable issue with PIN diodes lies in the method of biasing. In the existing low-frequency scenarios, printed biasing traces are commonly employed. The use of existing printed biasing traces, however, significantly impacts antenna performance at higher frequencies.

Millimeter wave (mm-wave) antennas are being used for emerging technologies like the 5G and 6G communication networks to improve wireless communication because they offer high gain and high bandwidth. Millimeter wave antennas, however, suffer from high path loss. Pattern reconfigurable antennas have therefore been proposed as one of the viable approaches in addressing the mm-wave high path loss. In literature, pattern reconfiguration has been achieved using a variety of techniques including the use of active elements like reconfigurable power dividers and PIN diodes, the use of a reconfigurable matching network, and an electromagnetic bandgap structure (EBG).

While the above-mentioned techniques have been successfully demonstrated in antenna pattern reconfiguration, their dependence on active devices like PIN diodes and reconfigurable power dividers is a challenge, especially in a 5G or 6G communication network where arrays of antennas are being proposed to solve the several connectivity issues. The power consumption of an array of active devices will lead to high power consumption for the entire system. The parasitic elements from these devices also limit the antenna performance.

### BRIEF SUMMARY

The following presents a simplified summary of dual band pattern reconfigurable millimeter wave antennas and related methods of the present disclosure to provide a basic understanding of the dual band pattern reconfigurable millimeter wave antennas and related methods of the present disclosure. This summary is not an extensive overview of the dual band pattern reconfigurable millimeter wave antennas and related methods of the present disclosure. It is not intended to identify key/critical elements of the dual band pattern reconfigurable millimeter wave antennas and related methods of the present disclosure or to delineate the scope of the dual band pattern reconfigurable millimeter wave antennas and related methods of the present disclosure. Its sole purpose is to present dual band pattern reconfigurable millimeter wave antennas and related methods of the present disclosure in a simplified form as a prelude to the more detailed description that is presented later.

In accordance with the dual band pattern reconfigurable millimeter wave antennas and related methods of the present disclosure, a dual band resonance pattern reconfigurable antenna may include a substrate and a u-shaped trace assembly supported by the substrate. In some examples, the u-shaped trace assembly is configured with at least one partition that divides the u-shaped trace assembly into at least two traces. In some examples, the antenna includes a patch antenna that includes a first end and a second end. The u-shaped trace assembly can be configured to partially surround the patch antenna. In some examples, a dual band pattern reconfigurable antenna is reconfigurable to selectively output any one of three different radiation patterns that can be used for sensing, while at the same time could also send and receive a communication signal at another frequency (e.g., at a milli-meter wave frequency in a range from 30 GHz to 300 GHZ).

In accordance with the present disclosure, an example dual band pattern reconfigurable millimeter wave antenna includes a substrate, a patch antenna, a trace assembly, a first PIN diode, and a second PIN diode. The patch antenna is supported by the substrate. The patch antenna has a first side perimeter, a second side perimeter disposed opposite to the first side perimeter, and a top side perimeter that that connects the first side perimeter and the second side perimeter. The trace assembly is supported by the substrate and partially surrounds the patch antenna. The trace assembly includes a first trace, a second trace, and a third trace. The first trace extends along a first trace length of the first side perimeter and is separated from the first side perimeter. The second trace extends along a second trace length of the second side perimeter and is separated from the second side perimeter. The third trace includes a third trace top side segment that extends along the top side perimeter. A first gap separates the third trace from the first trace. A second gap separates the third trace from the second trace. The first PIN diode is reconfigurable between a first PIN diode ON-state and a first PIN diode OFF-state. The first PIN diode is connected between the first trace and the third trace. The second PIN diode is reconfigurable between a second PIN diode ON-state and a second PIN diode OFF-state. The second PIN diode is connected between the second trace and the third trace. The dual resonance pattern reconfigurable antenna has a communication resonant frequency (fc) and a sensing resonant frequency (fs). The dual resonance pattern reconfigurable antenna is reconfigurable between a first biasing state, a second biasing state, and a third biasing state. The first PIN diode is in the first PIN diode ON-state and the second PIN diode is in the second PIN diode OFF-state in the first biasing state. The first PIN diode is in the first PIN diode OFF-state and the second PIN diode is in the second PIN diode ON-state in the second biasing state. The first PIN diode is in the first PIN diode ON-state and the second PIN diode is in the second PIN diode ON-state in the third biasing state.

The third trace can include one or more side segments. For example, the third trace can include a third trace first side segment that extends along a third trace length of the first side perimeter and is separated from the first side perimeter. The third trace can include a third trace second side segment that extends along a third trace length of the second side perimeter and is separated from the second side perimeter. The third trace first side segment and the first trace can be equal in length. The third trace second side segment and the second trace can be equal in length. Each of the first trace, the second trace, the third trace top side segment, the third trace first side segment, and the third trace second side segment can have an elongated rectangular shape.

The dual resonance pattern reconfigurable antenna can be configured to have a specified maximum beam scanning angle. For example, the dual resonance pattern reconfigurable antenna can be configured to have a maximum beam scanning angle of 120 degrees. In another example, the dual resonance pattern reconfigurable antenna can be configured to have a maximum beam scanning angle of 66 degrees.

The dual resonance pattern reconfigurable antenna can be configured to have gain greater than 4. For example, the dual resonance pattern reconfigurable antenna can be configured to have a gain of at least 5.4 dBi at fc in the third biasing state. The dual resonance pattern reconfigurable antenna can be configured to have a gain of at least 4.9 dBi at fs in the third biasing state.

The dual resonance pattern reconfigurable antenna can be configured to operate in or near the millimeter wave frequency range. For example, the dual resonance pattern reconfigurable antenna can be configured so that f_{c} is in a range from 30 to 300 GHz. The dual resonance pattern reconfigurable antenna can be configured so that fₛ is about 27.5 GHz. The dual resonance pattern reconfigurable antenna can be configured so that f_{c} is about 31.5 GHZ.

The dual resonance pattern reconfigurable antenna can be configured so that pattern reconfiguration is achieved for only one frequency. For example, the dual resonance pattern reconfigurable antenna can be configured so that pattern reconfiguration is achieved only at fs.

The dual resonance pattern reconfigurable antenna can include vias by which the first PIN diode and the second PIN diode are biased. For example, the dual resonance pattern reconfigurable antenna can include: (a) a first PIN diode biasing via that extends through the substrate by which the first PIN diode is biased, and (b) a second PIN diode biasing via that extends through the substrate by which the second PIN diode is biased. The dual resonance pattern reconfigurable antenna can include a ground plane, and the substrate can include: (a) a first slot formed around the first PIN diode biasing via to isolate the first PIN diode biasing via from the ground plane; and (b) a second slot formed around the second PIN diode biasing via to isolate the second PIN diode biasing via from the ground plane.

In accordance with the present disclosure, another example dual band pattern reconfigurable millimeter wave antenna includes a substrate, a patch antenna, a trace assembly, and a PIN diode. The patch antenna is supported by the substrate. The patch antenna has a first side perimeter, a second side perimeter disposed opposite to the first side perimeter, and a top side perimeter that that connects the first side perimeter and the second side perimeter. The trace assembly is supported by the substrate and partially surrounds the patch antenna. The trace assembly includes a first trace and a second trace. The first trace extends along a first trace length of the first side perimeter and is separated from the first side perimeter. The second trace includes a second trace top side segment that extends along the top side perimeter. A first gap separates the second trace from the first trace. The PIN diode is reconfigurable between a PIN diode ON-state and a PIN diode OFF-state. The PIN diode is connected between the first trace and the second trace. The dual resonance pattern reconfigurable antenna has a communication resonant frequency (fc) and a sensing resonant frequency (fs). The dual resonance pattern reconfigurable antenna is reconfigurable between a first biasing state and a second biasing state. The PIN diode is in the PIN diode ON-state in the first biasing state. The PIN diode is in the PIN diode OFF-state in the second biasing state.

The second trace can include one or more segments that extends along a side of the patch antenna. For example, the second trace can include a second trace first side segment that extends along a second trace length of the first side perimeter and is separated from the first side perimeter. The second trace can include a second trace second side segment that extends along a second trace length of the second side perimeter and is separated from the second side perimeter. Each of the first trace, the second trace top side segment, the second trace first side segment, and the second trace second side segment can have an elongated rectangular shape.

The dual resonance pattern reconfigurable antenna can include a via by which the PIN diode is biased. For example, the dual resonance pattern reconfigurable antenna can include: (a) a PIN diode biasing via that extends through the substrate by which the PIN diode is biased; and (b) a ground plane, and wherein the substrate comprises a slot formed around the PIN diode biasing via to isolate the PIN diode biasing via from the ground plane.

For a fuller understanding of the nature and advantages of dual band pattern reconfigurable millimeter wave antennas and related methods of the present disclosure, reference should be made to the ensuing detailed description and accompanying drawings.

### BRIEF DESCRIPTION OF THE DRAWINGS

FIG. 1 is an example application scenario involving a dual band pattern reconfigurable antenna, in accordance with antennas and method of the present disclosure.

FIG. 2 illustrates an example structure of a dual band pattern reconfigurable antenna, in accordance with antennas and method of the present disclosure.

FIG. 3A shows a photograph of the top side of a prototype dual band pattern reconfigurable antenna, in accordance with antennas and method of the present disclosure.

FIG. 3B shows a photograph of the bottom side of the prototype dual band pattern reconfigurable antenna of FIG. 3A.

FIG. 4A shows a plot of measured and simulated reflection coefficients for the prototype dual band pattern reconfigurable antenna of FIG. 3A in a first biased state.

FIG. 4B shows a plot of measured and simulated reflection coefficients for the prototype dual band pattern reconfigurable antenna of FIG. 3A in a second biased state.

FIG. 4C shows a plot of measured and simulated reflection coefficients for the prototype dual band pattern reconfigurable antenna of FIG. 3A in a third biased state.

FIG. 5A shows a plot of measured and simulated radiation patterns for the prototype dual band pattern reconfigurable antenna of FIG. 3A in the first biased state.

FIG. 5B shows a plot of measured and simulated radiation patterns for the prototype dual band pattern reconfigurable antenna of FIG. 3A in the second biased state.

FIG. 5C shows a plot of measured and simulated radiation patterns for the prototype dual band pattern reconfigurable antenna of FIG. 3A in the third biased state.

FIG. 6A shows a contour plot of surface current for the prototype dual band pattern reconfigurable antenna of FIG. 3A in the first biased state.

FIG. 6B shows a contour plot of surface current for the prototype dual band pattern reconfigurable antenna of FIG. 3A in the second biased state.

FIG. 6C shows a contour plot of surface current for the prototype dual band pattern reconfigurable antenna of FIG. 3A in the third biased state.

FIG. 7A shows a contour plot of the electric field on an XY plane at z=6 mm for the prototype dual band pattern reconfigurable antenna of FIG. 3A in the first biased state.

FIG. 7B shows a contour plot of the electric field on an XY plane at z=6 mm for the prototype dual band pattern reconfigurable antenna of FIG. 3A in the second biased state.

FIG. 7C shows a contour plot of the electric field on an XY plane at z=6 mm for the prototype dual band pattern reconfigurable antenna of FIG. 3A in the third biased state.

FIG. 8A illustrates another example geometry of a dual band pattern reconfigurable antenna with a capped patch, in accordance with antennas and method of the present disclosure.

FIG. 8B illustrates the example geometry of a dual band pattern reconfigurable antenna like the antenna of FIG. 8A, but with a capped patch with two cuts.

FIG. 9A shows plots of radiation patterns for the dual band pattern reconfigurable antennas of FIG. 8A and FIG. 8B.

FIG. 9B shows plots of radiation patterns for variations of the dual band pattern reconfigurable antenna of FIG. 8B.

FIG. 10 shows a plot of scanning angle as a function of the position of a cut along a right arm of a cap for an example dual band pattern reconfigurable antenna, in accordance with antennas and method of the present disclosure.

FIG. 11 shows plots of reflection coefficient for example dual band pattern reconfigurable antennas, in accordance with antennas and method of the present disclosure.

FIG. 12 shows plots of Gain as a function of frequency for example dual band pattern reconfigurable antennas, in accordance with antennas and method of the present disclosure.

### DETAILED DESCRIPTION

The present disclosure describes dual band pattern reconfigurable millimeter wave antennas and related methods. A dual band pattern reconfigurable millimeter wave antenna in accordance with the present disclosure is reconfigurable to emit different radiation patterns at a first frequency (which can be used for sensing purposes) combined with a communication output at another frequency (e.g., a millimeter frequency in a range from 30 GHz to 300 GHz). Example dual band pattern reconfigurable millimeter wave antennas in accordance with the present disclosure can include a rectangular patch antenna and an inverted U-shaped trace assembly resembling a cap around the rectangular patch antenna. As described herein the U-shaped trace assembly can include two, three, or more separated traces along its length that are connected by PIN diodes that can be selectively biased to selectively orient an antenna beam in a horizontal plane.

Dual Band Pattern Reconfigurable Antenna with +/−33 Degree Range.

As described herein, a prototype dual band pattern reconfigurable millimeter wave antenna was designed, fabricated, and evaluated. The prototype antenna demonstrated that the antenna beam can be steered to any one of three different directions (−33°, 0°, and 33°)at 27.5 GHz with a maximum measured gain of 4.9 dBi. The prototype antenna can be operated to simultaneously output a communication beam at 0 degrees (i.e., broadside) at 31.5 GHz with a maximum measured gain of 5.4 dBi. Good agreement is observed between simulated and measured parameters for both reflection coefficient and radiation pattern of the antenna.

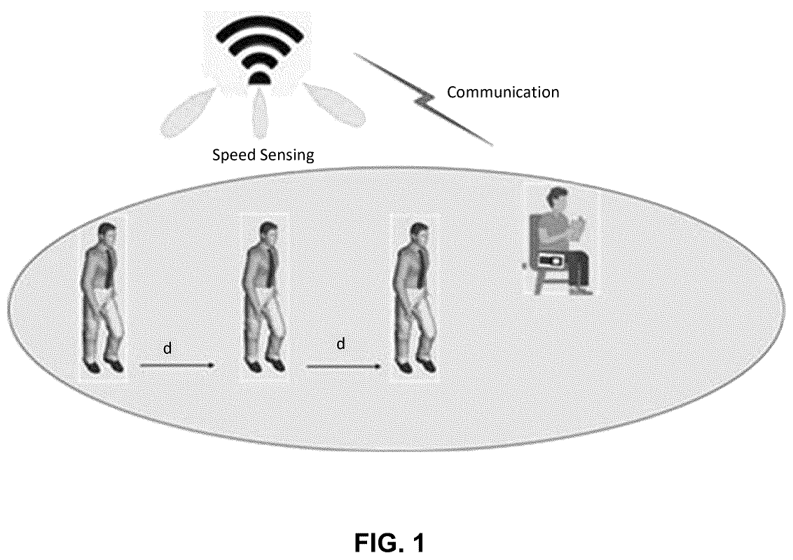

FIG. 1 illustrates a typical demonstration of Joint Communication and Sensing (JCAS) using a dual band pattern reconfigurable antenna, demonstrating the antenna's capability to direct a first antenna beam (at a first specific frequency, which could be used for sensing) in any one of three different directions, while at the same time could also send and receive a second signal at a second frequency (for communication purpose). The ability of the dual band pattern reconfigurable antennas in accordance with the present disclosure to direct an antenna radiation pattern in different directions makes the antennas disclosed herein ideal candidates for sensing applications such as localization and speed sensing.

In existing approaches, pattern reconfiguration has been accomplished through diverse techniques, including electrical switching, mechanical switching, and the use of meta-structures such as electromagnetic bandgap structures (EBG). Electronic pattern configuration techniques employ components such as PIN diodes, varactor diodes, radio frequency microelectromechanical systems (RF-MEMS), and radio frequency field-effect transistors (RF-FETs) to control the pattern of the antenna. Among these, the application of PIN diodes is prevalent due to its advantages, such as cost effectiveness and faster switching times. At lower frequencies (between 2 GHz to 10 GHZ), numerous designs for pattern reconfiguration using PIN diode have been proposed. In one approach, Yagi-Uda principle was employed for pattern reconfiguration, where two PIN diodes were used to vary the length of two parasitic elements, making them act either as a reflector or a director.

While existing approaches have demonstrated successful antenna pattern reconfiguration at low frequencies (between 2 GHz to 10 GHZ), their reliance on active devices such as PIN diodes and reconfigurable power dividers poses challenges particularly in the context of mm-wave communication. A notable issue with PIN diodes lies in the method of biasing. In the low-frequency scenarios, printed biasing traces are commonly employed; however, this approach becomes impractical at higher frequencies as it significantly impacts antenna performance. Consequently, pattern reconfigurable antennas at mm-wave frequencies are scarce, and the existing proposed designs are often complex. For example, in one existing approach, pattern reconfiguration of a dielectric resonator was achieved using a PIN diode and six EBGs each of 26 circularly shaped mushroom structure positioned around the resonator. Another existing approach employs a mm-wave pattern reconfigurable antenna featuring four antenna systems, a reconfigurable power divider, and a matching network. Additionally, the ratio of the number of switched beams to the number of PIN diodes employed raises concerns, as a higher number of PIN diodes can lead to increased power consumption and can render the antenna more delicate to handle.

The present disclosure introduces an uncomplicated design for dual band pattern reconfigurable millimeter wave antennas that can be used for simultaneous communication and sensing. The dual band pattern reconfigurable millimeter wave antennas disclosed herein exhibit two pivotal attributes—pattern reconfiguration and dual resonance in the mm-wave range—rendering the dual band pattern reconfigurable millimeter wave antennas disclosed herein well-suited for joint communication and sensing applications. Example dual band pattern reconfigurable millimeter wave antennas in accordance with the present disclosure include a rectangular patch antenna and an inverted U-shaped trace assembly resembling a cap that encloses the rectangular patch antenna on three of four sides. By strategically introducing cuts along the length of the U-shaped trace assembly, the antenna beam can be steered within a range of −33° to +33° using just two PIN diodes. Additionally, the U-shaped trace assembly induces the antenna to function as a slot antenna, thereby achieving dual resonance. To mitigate the impact of biasing traces on the antenna's plane, vias are employed for biasing the diodes from the back plane of the antenna.

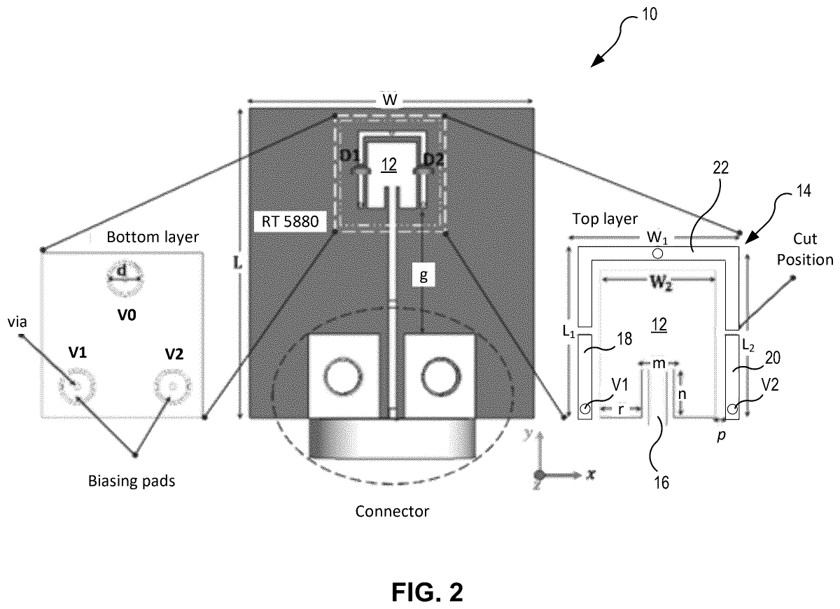

FIG. 2 illustrates a dual band pattern reconfigurable millimeter wave antenna 10, in accordance with the present disclosure. The antenna 10 includes a rectangular patch antenna 12 and U-shaped trace assembly 14 that surrounds the patch antenna 12 on three (left, top, and right) of four sides (left, top, right, and bottom). The patch antenna 12 has an inset feed 14. The U-shaped trace assembly 14 includes a first trace 18, a second trace 20, and a third trace 22. The traces 18, 20, 22 can be formed from any suitable conductive material such as, for example, copper. FIG. 2 includes a magnified view of a front side portion and a magnified view of a back side portion of the antenna 10 with annotated dimensional parameters.

The antenna 10 is designed to resonate at two frequencies, which are denoted herein by fₛ and f_{c}. The frequency fₛ can be used for sensing functionality and the frequency f_{c} can be used for communication as it is within the proposed frequency range for communication licensing. The rectangular patch antenna 12 is designed with resonance at f_{c} and its dimensions are W₂=0.4λ_{gc} and L₂=0.53λ_{gc}, where λ_{gc} is the wavelength in the effective material at fₛ. The resonance at fₛ is obtained by introducing the surrounding U-shaped trace assembly 14 with dimensions W₁=0.47λ_{gs} and L1=0.54λ_{gs}, where λ_{gs} is the wavelength in the effective media at fₛ.

The antenna 10 has two resonance modes: the patch mode and the slot mode. Since the dimensions of the U-shaped trace assembly 14 is slightly larger than the dimensions of the patch antenna 12, the sensing frequency fₛ is slightly lower than the communication frequency f_{c}. Beam pattern reconfiguration is accomplished by altering the surface current of the antenna 10. In the antenna 10, pattern reconfiguration manifested as steering the beam in the H-Plane is enabled by introducing a cut of width 0.2 mm on the two sides of the U-shaped trace assembly 14 as depicted in FIG. 2. In the antenna 10, a first PIN diode (D1) is connected to and between the first trace 18 and the third trace 22, and a second PIN diode (D2) is connected to and between the second trace 20 and the third trace 22. The electrical configuration of the U-Shaped trace assembly 14 determined by the ON/OFF states of the PIN diodes (D1, D2). For example, the U-shaped trace assembly 14 can be in a first biased state when the first PIN diode (D1) is in the ON-state and the second PIN diode (D2) is in the OFF-state. The U-shaped trace assembly 14 can be in a second biased state when the first PIN diode (D1) is in the OFF-state and the second PIN diode (D2) is in the ON-state. And the U-shaped trace assembly 14 can be in a third biased state when the first PIN diode (D1) is in the ON-state and the second PIN diode (D2) is in the ON-state. The first, second, and third biased states of the U-shaped trace assembly 14 can be selectively employed to produce a corresponding surface current distribution on the U-shaped trace assembly 14, which produces three different radiation pattern orientations at fₛ as described herein. Only the surface current of the slot mode is altered, and hence, radiation pattern reconfiguration is achieved only at fₛ. The cut position affects the magnitude of the configured angle of the radiation pattern. In the antenna 10, the cuts are disposed in the middle of each side of the U-shaped trace assembly 14 (as illustrated in FIG. 2).

The radiation pattern reconfiguration is controlled by using the first PIN diode (D1) to connect the first trace 18 and the third trace 22 or to isolate the first trace 18 from the third trace 22, and using the second PIN diode (D2) to connect the second trace 20 and the third trace 22 or isolate the second trace 20 from the third trace 22. In the antenna 10, the PIN diodes (D1, D2) are biased from the bottom layer (ground plane) of the antenna 10 through small vias (V1, V2) as shown in FIG. 2. A circular slot is created around each of the vias (V1, V2) to isolate the via from the RF ground. In FIG. 2, V1 and V2 represent the biasing pads for DI and D2 respectively while V0 represents the pad for the DC ground for the PIN diodes (D1, D2).

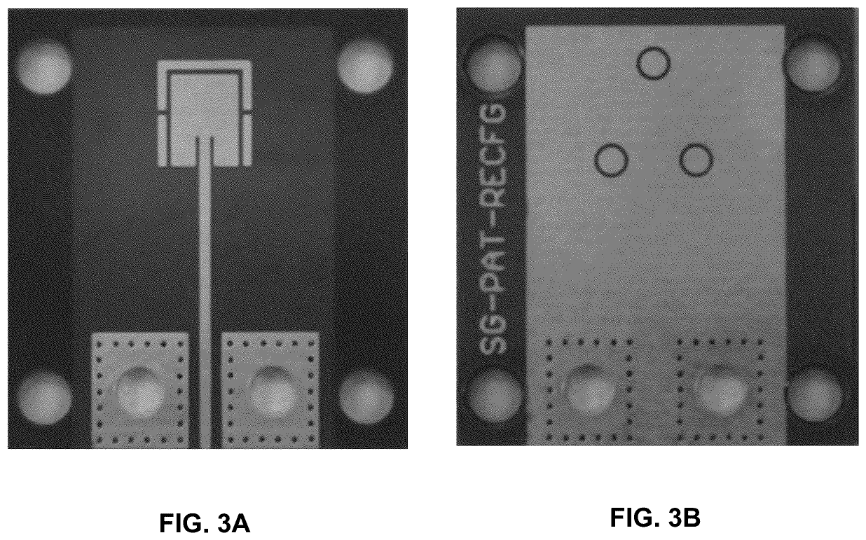

A prototype of the antenna 10 was fabricated on Rogers RT5880 substrate with relative permittivity of 2.2 and thickness of 0.8 mm. The antenna 10 was designed to operate at fₛ=27.5 GHZ and f_{c}=31.5 GHZ. The prototype of the antenna 10 was simulated and optimized using CST Studio Suite. Table I lists dimensional parameters and their corresponding optimized values for the prototype of the antenna 10. Additionally, a model of an edge mount connector (HK-LR-SR2) was incorporated into the simulation model to account for its effects. In simulation, the ON-state of each of the PIN diodes (D1, D2) was modeled as 5Ω resistor while the OFF-state was modeled as 0.018 pF, which correspond to the parameters of an example flip chip PIN diode. During measurement, the forward bias voltage and current for each PIN diode (D1, D2) was 1.8 V and 10 mA respectively while, the reverse bias voltage was 0 V. FIG. 3 shows pictures of the top and bottom layers of the fabricated prototype of the antenna 10.

TABLE I
Dimensional Parameters of the Prototype of the Antenna 10

| Parameter | Value (mm) | Parameter | Value (mm) |
|---|---|---|---|
| W | 14.5 | d | 1.00 |
| L | 15.86 | g | 6.42 |
| W₁ | 3.50 | m | 1 |
| L₁ | 3.97 | n | 1.12 |
| W₂ | 2.51 | r | 0.91 |
| L₂ | 3.43 | p | 0.19 |

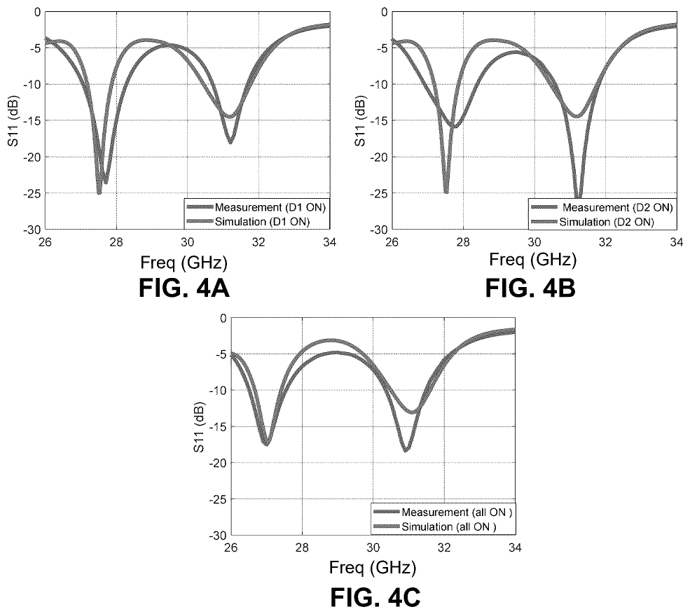

In FIG. 4A, FIG. 4B, and FIG. 4C, the reflection coefficient of the prototype of antenna 10 is presented for different biasing states of the PIN diodes (D1, D2). Notably, across all biasing states, the measured and simulated responses consistently matched below −10 dB at approximately 27.5 GHz with an operating bandwidth of about 1.4 GHz and 1.6 GHz at fₛ and f_{c}, respectively. Using the two PIN diodes (D1, D2), the total number of biasing states is four (11, 10, 10, and 00 states). Only 3 biasing states are shown because the patterns at 11 and 00 states are both steered to 0°. Moreover, when both PIN diodes (D1, D2) are off, there is current flow through biasing vias leading to low gain as compared to when both diodes are ON, hence, only when both are ON is shown.

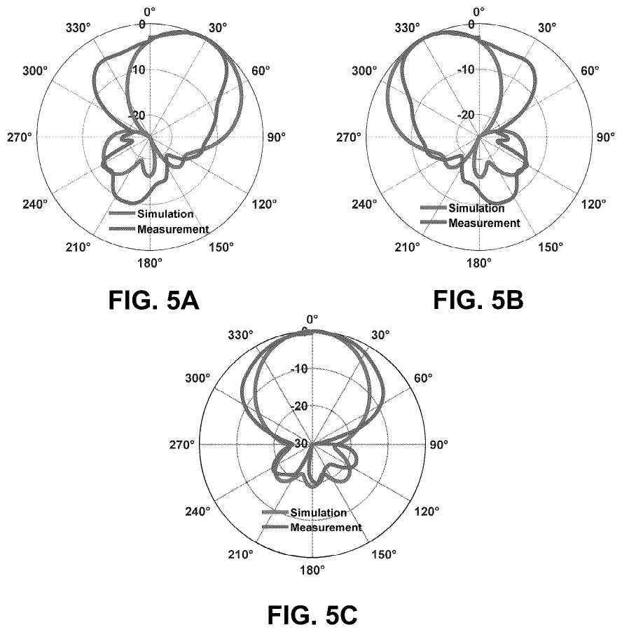

FIG. 5A, FIG. 5B, and FIG. 5C show plots of the radiation pattern of the prototype of the antenna 10 in the H-plane at 27.5 GHz for the three distinct biasing states of the PIN diodes (D1, D2). The antenna radiation pattern is steered in the H-plane using the different biasing states of the PIN diodes, as summarized in Table II. The obtained results confirm that the prototype of the antenna 10 can direct its radiation beam in three different directions using only two PIN diodes. The results show a good agreement between measurement and simulation. The antenna 10 achieves a maximum beam-scanning angle of 66°, spanning from −33° to 33°. The antenna 10 gains for the different D1 and D2 biasing states were also measured. The measured gains are presented in Table III. The maximum measured gain of the antenna 10 was 5.4 dBi at f_{c} and 4.9 dBi at fₛ which was achieved when both diodes were ON.

TABLE II
Biasing States of the Pin Diodes and Corresponding Beam Angles

| Biasing States | D1 | D2 | Beam Angle |
|---|---|---|---|
| 1 | 1 | 0 | +33° |
| 2 | 0 | 1 | −33° |
| 3 | 1 | 1 | 0° |

TABLE III
Measured and Simulated Gain of the Antenna 10 at fₛ and f_{c}

| | fₛ | | f_{c} | |
|---|---|---|---|---|
| | Simulated | Measured | Simulated | Measured |
| Biasing State | (dBi) | (dBi) | (dBi) | (dBi) |
| All ON | 6 | 4.9 | 7 | 5.4 |
| One ON | 4.4 | 4.4 | 5.9 | 5 |

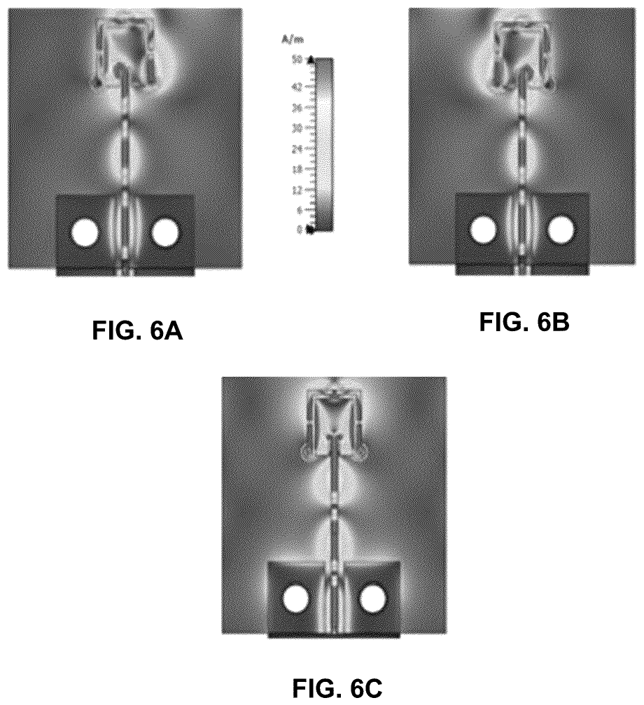

Simulated surface currents of the prototype of the antenna 10 at fₛ is shown in FIG. 6A, FIG. 6B, and FIG. 6C. When both PIN diodes (D1, D2) are ON, it can be observed that the two slot are excited equally as depicted in FIG. 6C. In contrast, when only one of the PIN diodes (D1, D2) is ON, it can be observed that one of the slots is excited more than the other as depicted in FIG. 6A and FIG. 6B.

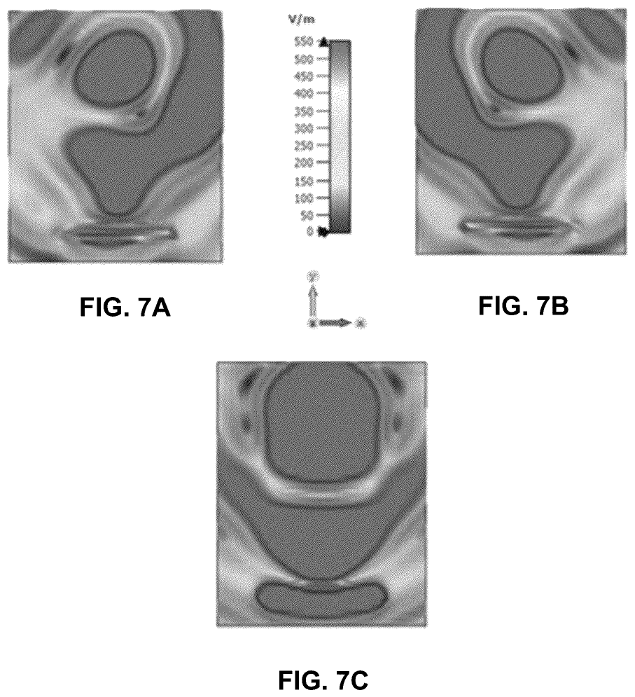

Furthermore, to explain the pattern reconfigurability of the antenna 10, the E-field distribution of the antenna 10 in the xy-plane at z=6 mm above the antenna (which is within the near field of the antenna) for different biasing states of the PIN diodes (D1, D2) are presented in FIG. 7A, FIG. 7B, and FIG. 7C. When one of the PIN diodes (D1, D2) is in the ON state, the E-field is concentrated on one side of the antenna 10. For example, when the first PIN diode (D1) is in the ON state, the E-field is concentrated on the right side of the U-shaped trace assembly 14 indicating a beam steering as depicted in FIG. 7A. On the other hand, when both PIN diodes (D1, D2) are ON, the E-field is concentrated at the center of the antenna 10, indicating that the pattern is at 0° as illustrated in FIG. 7C.

Dual Band Pattern Reconfigurable Antenna with +/−60Degree Range.

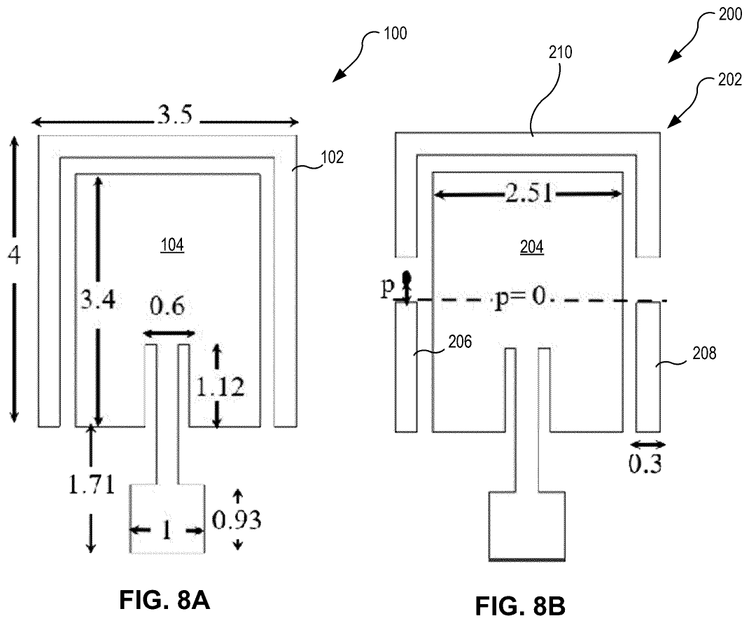

FIG. 8A illustrates another example geometry of a dual band pattern reconfigurable antenna 100 with a U-shaped trace assembly 102, in accordance with antennas and method of the present disclosure. FIG. 8B illustrates the example geometry of a dual band pattern reconfigurable antenna 200 like the antenna 100 of FIG. 8A, but with a U-shaped trace assembly 202 with two trace discontinuities. By incorporating discontinuities in the U-shaped trace assembly 202 such that the U-shaped trace assembly 202 is divided into a first trace 204, a second trace 206, and a third trace 208, the antenna beam output by the antenna 200 can be steered within the range of −60° to +60°.

The antenna 200 is design on a 6.86 mm by 5 mm Rogers RT5880 substrate with a thickness of 0.75 mm, relative permittivity of 2.2, and loss tangent of 0.0009. All dimensions are in mm. Initially, a standard rectangular patch antenna 104, 204 with an inset feed was designed to resonate at 28 GHz. A step-in-width feeding line is used for better matching. The vertical distance from the center of the patch to the center of the cut is p while the length of the cut is 0.6 mm.

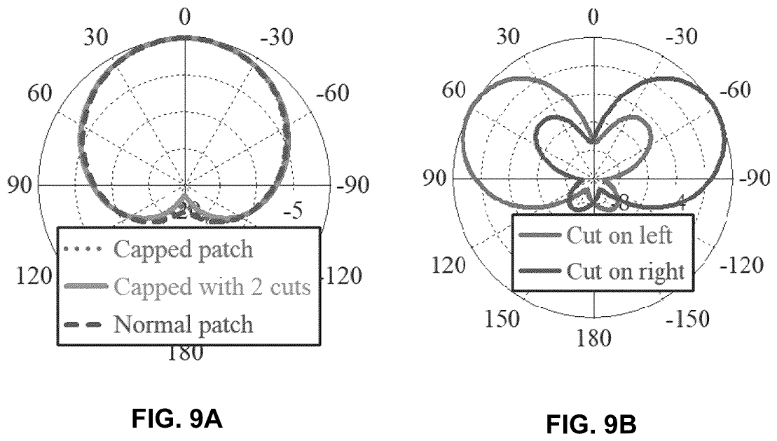

The antenna 200 was simulated using CST Studio Suite. FIG. 9A shows the radiation patterns in the H-plane) (ϕ=0°) for a variation of the antenna 100 with a regular patch without the U-shaped trace assembly, the antenna 100, and the antenna 200. The results show that the U-shaped trace assembly does not affect the radiation pattern configuration. Moreover, having two trace discontinuities symmetrically placed on the U-shaped trace assembly neutralizes the beam tilting effect due to the cut. FIG. 9B, however, shows that beam tilting is achieved with a trace discontinuity on only one of the two sides (right or left) of the U-shaped trace assembly. The beam tilting is only in the H-plane) (ϕ=0°) while the radiation pattern in the E-plane (ϕ=90o) remains unchanged regardless of the position of the trace discontinuity.

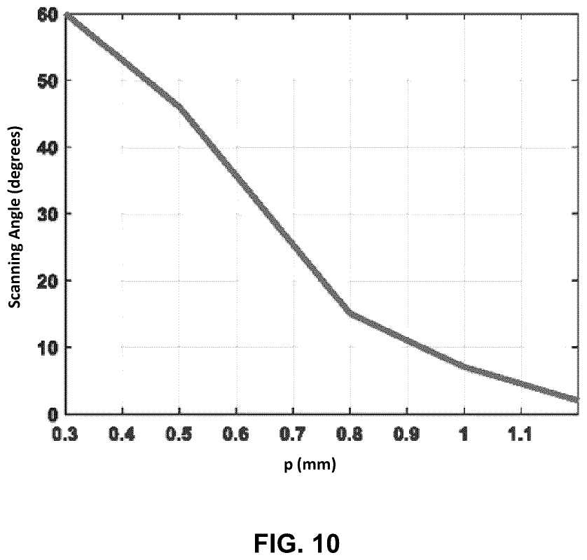

In order to vary the amount of steering of the radiation beam, the trace discontinuity position can be varied. In FIG. 9B, a maximum beam scanning angle of 60° was achieved when p=0.3 mm (i.e., when the vertical distance between the center of the patch antenna and the center of the trace discontinuity is 0.3 mm). The pattern is observed to be in the direction of the cut. Hence, the pattern reconfiguration follows the Yagi Uda operation, where the longer part of the cap acts as a reflector and the smaller as a director. The change in the beam direction is due to the difference in length between the director and the length of the patch antenna. FIG. 10 shows how the position of the cut affects the magnitude of the scanning angle.

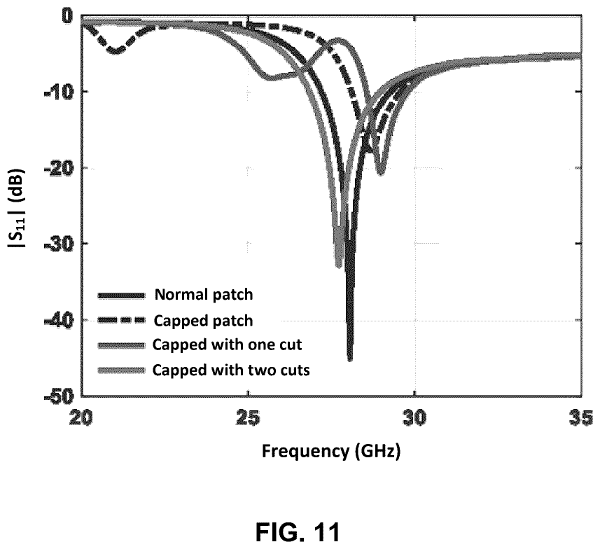

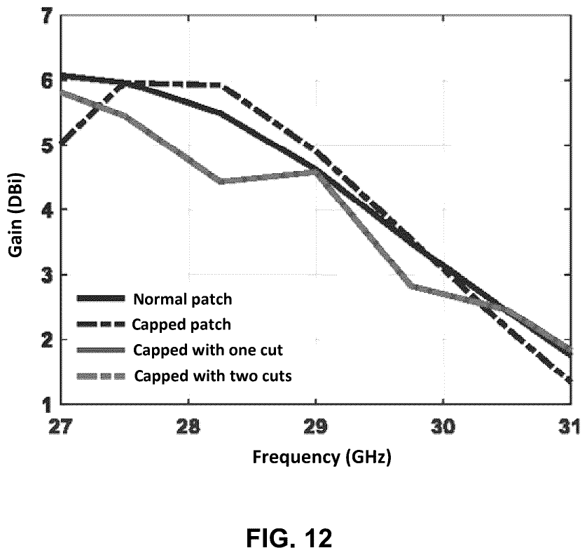

FIG. 11 shows the reflection coefficient of the antenna. It can be observed that the antenna resonates around 28 GHz with a slight shift in resonant frequency when a trace discontinuity is incorporated into the U-shaped trace assembly. The patch antenna is matched to 50Ω with a −10 dB impedance bandwidth of 28.5-29.8 GHz for the U-shaped trace assembly with one trace discontinuity. FIG. 12 shows antenna gain vs frequency for different configurations of the antenna. It can be observed that one or more trace discontinuities incorporated into the U-shaped trace assembly have a minor impact on the gain of the antenna. cap and the cuts on the cap have less effect on the performance of the antenna.

The reconfigurable patch antenna 200 operates in the band of 28.5 GHz to 29.8 GHz with a maximum tilting angle of 60°. Beam tilting is achieved using a trace of metal placed around the patch in the form of a cap with a cut on one side of the trace. The cut position along the length of the cap can be used to change the antenna beam tilt angle. The antenna can be employed in mm-wave 5G and 6G antenna array designs.

The following references are directed to antenna aspects relevant to the dual band pattern reconfigurable antennas and related methods of the present disclosure. Each of the following references is incorporated herein by reference in its entirety:
1. W. Hong et al., “The role of millimeter-wave technologies in 5G/6G wireless communications,” IEEE J. Microwaves., vol. 1, no. 1, pp. 101-122, January 2021;
2. P. Soontornpipit, C. M. Furse, You Chung Chung and B. M. Lin, “Optimization of a buried microstrip antenna for simultaneous communication and sensing of soil moisture,” IEEE Trans. Antennas Propag., vol. 54, no. 3, pp. 797-800, March 2006;
3. L. Ma, J. Lai, Y. Yin, C. Xia, C. Gu, and J. Mao, “A wideband co-linearly polarized full-duplex antenna-in-package with high isolation for integrated sensing and communication,” IEEE Antennas Wireless Propag. lett., vol. 22, no. 9, pp. 2185-2189;
4. S. Pramono et al., “Circularly polarized lunar regolith simulant antenna for future communication and remote sensing in lunar environment,” IEEE Antennas Wireless Propag. lett., vol. 22, no. 12, pp. 2988-2992 December 2023;
5. X. Deng et al., “Axial ratio bandwidth enhancement of DBDCP Fabry-Pérot cavity antenna for vehicular MIMO Communications and Sensing,” IEEE Trans. Veh. Technol., pp. 1-9, 2023;
6. S. Yang, L. Liang, Z. Li, and W. Wang, “Ultra-Wideband MIMO circularly-polarized cube antenna with characteristic mode analysis for wireless communication and sensing,” IEEE Internet Things J., pp. 1-1, 2023;
7. A. Raza, R. Keshavarz, E. Dutkiewicz and N. Shariati, “Compact multiservice antenna for sensing and communication using reconfigurable complementary spiral resonator,” IEEE Trans. Instrum. Meas., vol. 72, pp. 1-9, 2023, Art no. 8004509;
8. N. O. Parchin, H. J. Basherlou, Y. IA. Al-Yasir, A. M. Abdulkhaleq, and R. A. Abd-Alhameed. “Reconfigurable antennas: Switching techniques—A survey.” Electronics, vol. 9, no. 2, p. 336, 2020;
9. S. Gaya, H. Attia, S. I. Sheikh, A. Mahmoud and M. S. Sharawi, “A Yagi-Uda pattern reconfigurable antenna for WiMAX application,” 2019 IEEE International Symposium on Antennas and Propagation and USNC-URSI Radio Science Meeting, Atlanta, GA, USA, 2019, pp. 679-680;
10. J. Hao, J. Ren, X. Du, J. H. Mikkelsen, M. Shen and Y. Z. Yin, Pattern reconfigurable Yagi-Uda antenna based on liquid metal,” IEEE Antennas Wireless Propag. lett., vol. 20, no. 4, pp. 587-591, April 2021;
11. L. Santamaria, F. Ferrero, R. Staraj and L. Lizzi, “Slot-based pattern reconfigurable ESPAR antenna for IoT applications,” IEEE Trans. Antennas Propag., vol. 69, no. 7, pp. 3635-3644 July 2021;
12. S. A. Haydhah, F. Ferrero, L. Lizzi, M. S. Sharawi and A. Zerguine, “A multifunctional compact pattern reconfigurable antenna with four radiation patterns for sub-GHz IoT applications,” IEEE Open J. Antennas Propag., vol. 2, pp. 613-622;
13. W. Li, Y. Zhao, X. Ding, L. Wu and Z. Nie, “A wideband pattern reconfigurable loop antenna designed by using characteristic mode analysis,” IEEE Antennas Wireless Propag. lett., vol. 21, no. 2, pp. 396-400, February 2022;
14. M. Li, Z. Zhang, M.-C. Tang, L. Zhu, and N.-W. Liu, “Bandwidth enhancement and size reduction of a low-profile polarization reconfigurable antenna by utilizing multiple resonances,” IEEE Trans. Antennas Propag., vol. 70, no. 2, pp. 1517-1522 February 2022;
15. Z. Wang, S. Liu and Y. Dong, “Compact wideband pattern reconfigurable antennas inspired by end-fire structure for 5G vehicular communication,” IEEE Trans. Veh. Technol., vol. 71, no. 5, pp. 4655-4664 May 2022;
16. W.-S. Chang, C.-F. Yang, C.-K. Chang, W.-J. Liao, L. Cho, and W.-S. Chen, “Pattern reconfigurable millimeter-wave antenna design for 5G handset applications,” 2016 10th European Conference on Antennas and Propagation (EuCAP), Davos, Switzerland, 2016;
17. H. Pablo Zapata Cano, Z. D. Zaharis, T. V. Yioultsis, N. V. Kantartzis and P. I. Lazaridis, “Pattern reconfigurable antennas at millimeter-wave frequencies: A comprehensive survey,” IEEE Access, vol. 10, pp. 83029-83042, 2022;
18. R. Reese et al., “A millimeter-wave beam-steering lens antenna with reconfigurable aperture using liquid crystal,” IEEE Trans. Antennas Propag., vol. 67, no. 8, pp. 5313-5324 August 2019;
19. I. Ben Mabrouk, M. Al-Hasan, M. Nedil, T. A. Denidni and A.-R. Sebak, “A novel design of radiation pattern-reconfigurable antenna system for millimeter-wave 5G applications,” IEEE Trans. Antennas Propag., vol. 68, no. 4, pp. 2585-2592 April 2020;
20. S. Tang, Y. Zhang, Z. Han, C.-Y. Chiu and R. Murch, “A pattern reconfigurable antenna for single-RF 5G millimeter-wave communications,” IEEE Antennas Wireless Propag. lett., vol. 20, no. 12, pp. 2344-2348 December 2021;
21. C. Fan, B. Wu, Y. Hu, Y. Zhao and T. Su, “Millimeter-wave pattern reconfigurable vivaldi antenna using tunable resistor based on graphene,” IEEE Trans. Antennas Propag., vol. 68, no. 6, pp. 4939-4943 June 2020;
22. S. Gaya, A. A. Mustapha and M. A. Abou-Khousa, “Pattern reconfigurable capped patch antenna for mm-wave 5G applications,” 2023 IEEE International Symposium on Antennas and Propagation and USNC-URSI Radio Science Meeting (USNC-URSI), Portland, OR, USA, 2023, pp. 627-628;
23. URL www.federalregister.gov/documents/2016/01/13/2015-31852/use-of-spectrum-bands-above-24-ghz-for-mobile-radioservices# print;
24. HK-LR-SR2 (12), https://www.hirose.com/en/product/p/CL0338-0079-0-12# (accessed Dec. 26, 2023);
25. URL cdn.macom.com/datasheets/MA4AGP907_FCP910.pdf; and
26. C. A. Balanis, Antenna theory: analysis and design. John wiley & sons, 2016.

Other variations are within the spirit of the antennas and methods of the present disclosure. Thus, while the antennas and methods of the present disclosure are susceptible to various modifications and alternative constructions, certain illustrated examples thereof are shown in the drawings and have been described above in detail. It should be understood, however, that there is no intention to limit the antennas and methods of the present disclosure to the specific form or forms disclosed, but on the contrary, the antennas and methods of the present disclosure are to cover all modifications, alternative constructions, and equivalents falling within the spirit and scope of the antennas and methods of the present disclosure, as defined in the appended claims.

The use of the terms “a” and “an” and “the” and similar referents in the context of describing the antennas and methods of the present disclosure (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better describe the antennas and methods of the present disclosure and does not pose a limitation on the scope of the antennas and methods of the present disclosure unless otherwise claimed. No language in the specification should be construed as indicating any non-claimed element as essential to the practice of the antennas and methods of the present disclosure.

Preferred antennas and methods of the present disclosure are described herein, including the best mode known to the inventors for carrying out the antennas and methods of the present disclosure. Variations of those preferred antennas and methods of the present disclosure may become apparent to those of ordinary skill in the art upon reading the foregoing description. The inventors expect skilled artisans to employ such variations as appropriate, and the inventors intend for the antennas and methods of the present disclosure to be practiced otherwise than as specifically described herein. Accordingly, the antennas and methods of the present disclosure include all modifications and equivalents of the subject matter recited in the claims appended hereto as permitted by applicable law. Moreover, any combination of the above-described elements in all variations thereof is encompassed by the antennas and methods of the present disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A dual resonance pattern reconfigurable antenna comprising:
a substrate;
a patch antenna supported by the substrate, wherein the patch antenna has a first side perimeter, a second side perimeter disposed opposite to the first side perimeter, and a top side perimeter that that connects the first side perimeter and the second side perimeter,
a trace assembly supported by the substrate and partially surrounding the patch antenna, wherein the trace assembly comprises a first trace, a second trace, and a third trace, wherein the first trace extends along a first trace length of the first side perimeter and is separated from the first side perimeter, wherein the second trace extends along a second trace length of the second side perimeter and is separated from the second side perimeter, wherein the third trace comprises a third trace top side segment that extends along the top side perimeter, wherein a first gap separates the third trace from the first trace, and wherein a second gap separates the third trace from the second trace;
a first PIN diode having a first PIN diode ON-state and a first PIN diode OFF-state, wherein the first PIN diode is connected between the first trace and the third trace; and
a second PIN diode having a second PIN diode ON-state and a second PIN diode OFF-state, wherein the second PIN diode is connected between the second trace and the third trace,
wherein:
the dual resonance pattern reconfigurable antenna has a communication resonant frequency (fc) and a sensing resonant frequency (fs);
the dual resonance pattern reconfigurable antenna is reconfigurable between a first biasing state, a second biasing state, and a third biasing state;
the first PIN diode is in the first PIN diode ON-state and the second PIN diode is in the second PIN diode OFF-state in the first biasing state;
the first PIN diode is in the first PIN diode OFF-state and the second PIN diode is in the second PIN diode ON-state in the second biasing state; and
the first PIN diode is in the first PIN diode ON-state and the second PIN diode is in the second PIN diode ON-state in the third biasing state.

2. The dual resonance pattern reconfigurable antenna of claim 1, wherein the third trace further comprises a third trace first side segment that extends along a third trace length of the first side perimeter and is separated from the first side perimeter.

3. The dual resonance pattern reconfigurable antenna of claim 2, wherein the third trace further comprises a third trace second side segment that extends along a third trace length of the second side perimeter and is separated from the second side perimeter.

4. The dual resonance pattern reconfigurable antenna of claim 3, wherein:
the third trace first side segment and the first trace are equal in length; and
the third trace second side segment and the second trace are equal in length.

5. The dual resonance pattern reconfigurable antenna of claim 4, wherein each of the first trace, the second trace, the third trace top side segment, the third trace first side segment, and the third trace second side segment has an elongated rectangular shape.

6. The dual resonance pattern reconfigurable antenna of claim 1, having a maximum beam scanning angle of 120 degrees.

7. The dual resonance pattern reconfigurable antenna of claim 1, having a maximum beam scanning angle of 66 degrees.

8. The dual resonance pattern reconfigurable antenna of claim 1, having a gain of at least 5.4 dBi at f_{c} in the third biasing state.

9. The dual resonance pattern reconfigurable antenna of claim 1, having a gain of at least 4.9 dBi at fₛ in the third biasing state.

10. The dual resonance pattern reconfigurable antenna of claim 1, wherein f_{c} is in a range from 30 to 300 GHz.

11. The dual resonance pattern reconfigurable antenna of claim 9, wherein fₛ is about 27.5 GHz.

12. The dual resonance pattern reconfigurable antenna of claim 9, wherein f_{c} is about 31.5 GHz.

13. The dual resonance pattern reconfigurable antenna of claim 1, wherein pattern reconfiguration is achieved only at fₛ.

14. The dual resonance pattern reconfigurable antenna of claim 1, further comprising:
a first PIN diode biasing via that extends through the substrate by which the first PIN diode is biased; and
a second PIN diode biasing via that extends through the substrate by which the second PIN diode is biased.

15. The dual resonance pattern reconfigurable antenna of claim 13, further comprising a ground plane, and wherein the substrate comprises:
a first slot formed around the first PIN diode biasing via to isolate the first PIN diode biasing via from the ground plane; and
a second slot formed around the second PIN diode biasing via to isolate the second PIN diode biasing via from the ground plane.

16. A dual resonance pattern reconfigurable antenna comprising:
a substrate;
a patch antenna supported by the substrate, wherein the patch antenna has a first side perimeter, a second side perimeter disposed opposite to the first side perimeter, and a top side perimeter that that connects the first side perimeter and the second side perimeter,
a trace assembly supported by the substrate and partially surrounding the patch antenna, wherein the trace assembly comprises a first trace and a second trace, wherein the first trace extends along a first trace length of the first side perimeter and is separated from the first side perimeter, wherein the second trace comprises a second trace top side segment that extends along the top side perimeter, wherein a first gap separates the second trace from the first trace;
a PIN diode having a PIN diode ON-state and a PIN diode OFF-state, wherein the PIN diode is connected between the first trace and the second trace; and
wherein:
the dual resonance pattern reconfigurable antenna has a communication resonant frequency (fc) and a sensing resonant frequency (fs);
the dual resonance pattern reconfigurable antenna is reconfigurable between a first biasing state and a second biasing state;
the PIN diode is in the PIN diode ON-state in the first biasing state; and
the PIN diode is in the PIN diode OFF-state in the second biasing state.

17. The dual resonance pattern reconfigurable antenna of claim 16, wherein the second trace further comprises a second trace first side segment that extends along a second trace length of the first side perimeter and is separated from the first side perimeter.

18. The dual resonance pattern reconfigurable antenna of claim 17, wherein the second trace further comprises a second trace second side segment that extends along a second trace length of the second side perimeter and is separated from the second side perimeter.

19. The dual resonance pattern reconfigurable antenna of claim 18, wherein each of the first trace, the second trace top side segment, the second trace first side segment, and the second trace second side segment has an elongated rectangular shape.

20. The dual resonance pattern reconfigurable antenna of claim 16, further comprising:
a PIN diode biasing via that extends through the substrate by which the PIN diode is biased; and
a ground plane, and wherein the substrate comprises a slot formed around the PIN diode biasing via to isolate the PIN diode biasing via from the ground plane.
